(19) United States
(12) Patent Application Publication
(10) Pub. No.: US 2011/0314415 A1
(43) Pub. Date: Dec. 22, 2011

(54) Method and System for Providing Custom Tooltip Messages

(76) Inventors: George FITZMAURICE, Toronto (CA); Tovi Grossman, Toronto (CA); Wei Li, Waterloo (CA); Justin Frank Matejka, Etobicoke (CA)

(21) Appl. No.: 12/820,012

(22) Filed: Jun. 21, 2010

(51) Int. Cl. G06F 3/048

(52) U.S. Cl. 715/808; 715/810

(57) ABSTRACT

A computer-implemented method for providing custom tooltips to an end-user of a software application. The method includes receiving a selection of a user interface (UI) element associated with the software application; and causing a custom tooltip to be displayed on a display device in response to the selection, where the custom tooltip includes one or more custom tooltip entries associated with the selected UI element created by one or more users.

### BACKGROUND OF THE INVENTION

1. Field of the Invention

Embodiments of the invention relate generally to computer software and, more specifically, to a method and system for providing custom tooltip messages.

2. Description of the Related Art

A wide variety of software applications are currently available to end-users, including computer-aided design (CAD) applications, computer graphics applications, animation applications, word processing applications, and computer programming applications, among others. Many of these software applications allow an end-user to interact with the software application via a graphical user interface (GUI). Conventional GUIs often provide the end-user with access to a set of tools that can be used to perform various operations within a workspace provided by the software application. For example, a CAD application could provide a set of drawing tools that can be used to draw different shapes within a drawing workspace provided by the CAD application. Each tool in the set of tools could be represented with an icon within the GUI that the end-user selects to use the tool.

Typically, teams of individuals collaborate on a project using a similar piece of software. For example, a team of civil engineers may collaborate to design a new building using a CAD application. During the course of the project, individual team members or managers may want to send a message to the other team members. The message may be a status update, a design detail, or any other type of message. To convey the message, the team member could send an electronic mail (email) to the other team members. Another way of communicating the message to the other team members could be to schedule a meeting, e.g., conference call, web-based meeting, or in-person meeting.

One problem with the above collaboration techniques is that the communicated information is difficult for individuals to organize, maintain, and/or access. Emails are often deleted or require specific search terms to locate, such as when an individual is seeking information pertaining to a particular tool. Team meetings are time consuming and require each individual to maintain a strict organization of his or her notes. Accordingly, the content of messages communicated is often forgotten or lost, and, therefore, not effective.

As the foregoing illustrates, there is a need in the art for an improved technique to communicate with other individuals using a common software application.

### SUMMARY OF THE INVENTION

A computer-implemented method for providing custom tooltips to an end-user of a software application. In some embodiments, a tooltip is a graphical element, such as text or a window, that is displayed when a mouse cursor is positioned over a particular user interface element. The method includes receiving a selection of a user interface (UI) element associated with the software application; and causing a custom tooltip to be displayed on a display device in response to the selection, where the custom tooltip includes one or more custom tooltip entries associated with the selected UI element created by one or more users.

Advantageously, the end-user is able to easily access, generate, modify, and/or communicate to others information relevant to the UI element.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a computer system configured to implement one or more aspects of the invention;

FIG. 2A is a conceptual diagram that illustrates a custom tooltip, according to one embodiment of the invention;

FIG. 2B is a conceptual diagram that illustrates a new custom tooltip entry within a custom tooltip, according to one embodiment of the invention;

FIG. 3 is a conceptual diagram that illustrates a custom tooltip displayed within a software application, according to one embodiment of the invention;

FIG. 4 is a flow diagram of method steps for displaying a custom tooltip, according to one embodiment of the invention; and

FIG. 5 is a flow diagram of method steps for adding a custom tooltip entry to a custom tooltip, according to one embodiment of the invention.

### DETAILED DESCRIPTION

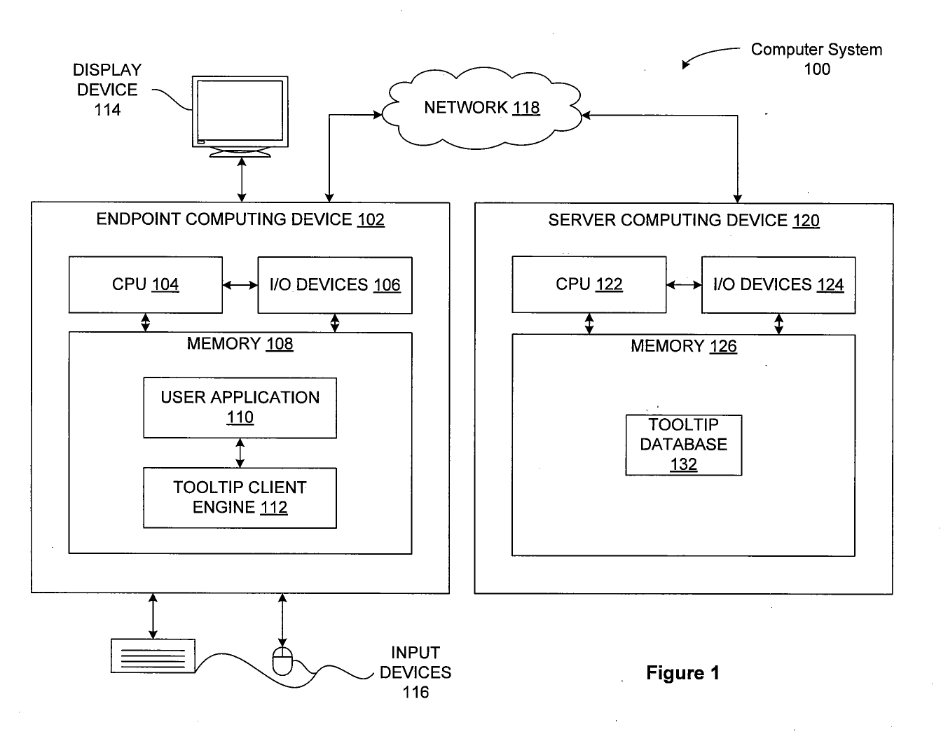

FIG. 1 illustrates a computer system 100 configured to implement one or more aspects of the invention. As shown, the computer system 100 includes an endpoint computing device 102 coupled to a server computing device 120 via a network 118. The network 118 may be any technically feasible type of network that allows data to be exchanged between the endpoint computing device 102 and the server computing device 120, including a wide area network (WAN), a local area network (LAN), a wireless (WiFi) network, or the Internet, among others.

The endpoint computing device 102 may be a desktop computer, a laptop computer, a cell phone, a personal digital assistant (PDA), or any other type of computing device configured to receive input, process data, and/or display images. The endpoint computing device 102 receives input from an end-user via the input devices 116 and displays graphical images to the end-user via the display device 114. The endpoint computing device 102 includes one or more central processing units 104, one or more input/output (I/O) devices 106, and a memory 108.

The CPU 104 may be implemented as a graphics processing unit (GPU), an application-specific integrated circuit (ASIC), a field programmable gate array (FPGA), or another type of processing unit. The CPU 104 may be configured to execute program instructions associated with a particular instruction set architecture (ISA) specific to the CPU 104. The CPU 104 may also be configured to receive data from and transmit data to the I/O devices 106 and the memory 108.

The I/O devices 106 include devices that may be used to input data to the endpoint computing device 102 or devices that output data from the endpoint computing device 102. The I/O devices 106 may include input devices, such as a joystick, a switch, a microphone, a video camera, or a touchpad, among others, as well as output devices, such as a speaker, a projector, or a lamp, among others. In addition, the I/O devices 106 may include devices used to input or output data to or from, respectively, the endpoint computing device 102, such as an Ethernet port, a serial port, a compact disc (CD) drive, or a digital video disc (DVD) drive, among others. The I/O devices 106 are configured to couple the endpoint computing device 102 to the server computing device 120 via the network 118. In one embodiment, the I/O devices 106 include the input devices 116 and the display device 114. The I/O devices 106 may be used to transmit data to and receive data from the CPU 104 and may also write data to and read data from the memory 108.

The memory 108 may be a hard disk, a flash memory stick, a compact disc read-only memory (CD-ROM), a random access memory (RAM) module, or any other type of volatile or non-volatile memory unit capable of storing data. The memory 108 includes various software programs that can be executed by the CPU 104. The software programs included in the memory 108 are configured to receive information from and transmit information to the server computing device 120 via the network 118.

The server computing device 120 may be a desktop computer, a laptop computer, a cell phone, a personal digital assistant (PDA), or any other type of computing device. The server computing device 120 includes one or more CPUs 122, one or more I/O devices 124, and more or more memories 126. The CPU 122 may be implemented as a GPU, and ASIC, an FPGA, or another type of processing unit. The CPU 122 may be configured to execute program instructions associated with a particular ISA specific to the CPU 122. The CPU 122 may also be configured to receive data from and transmit data to the I/O devices 124 and the memory 126.

The I/O devices 124 may include some or all of the same I/O devices as those included in the I/O devices 106. The I/O devices 104 are configured to couple the server computing device 120 to the endpoint computing device 102 via the network 118. The I/O devices 124 may be used to transmit data to and receive data from the CPU 122 and may also write data to and read data from the memory 126

The memory 126 may be a hard disk, a flash memory stick, a CD-ROM, a RAM module, or any other type of volatile or non-volatile memory unit capable of storing data. The memory 126 includes various software programs that can be executed by the CPU 122. The software programs included in the memory 126 are configured to transmit information to and receive information from the endpoint computing device 102 via the network 118. The software programs included in the memory 108 of the endpoint computing device 102 and the software programs included in the memory 126 are configured to exchange data via the network 118. As shown, a user application 110 and a tooltip client engine 112 are included within the memory 108 of the endpoint computing device 102.

The user application 110 stored in the memory 108 may be a computer-aided design (CAD) application, a computer graphics application, an animation application, a word processing application, or a computer programming application, among others. The user application 110 comprises program instructions than can be executed by the CPU 104. The user application 110 is configured to receive data from an end-user of the endpoint computing device 102 via the input devices 116 and to display graphical images to the end-user via the display device 114. In some embodiments, the user application 110 is not stored in the memory 108 within the endpoint computing device 102 and, instead, is stored in the server computing device 120 or another computing device (not shown). In still further embodiments, the user application 110 is stored in one or more computing devices comprising a distributed computing environment.

The user application 110 is configured to generate a graphical user interface (GUI) and to display the GUI to the end-user via the display device 114. The GUI generated by the user application 110 is referred to herein as an “application GUI.” The application GUI provides the end-user with access to various tools that allows the end-user to manipulate data, such as graphical data or textual data, among other types of data. For example, when the software application is a CAD application, the application GUI could provide a drafting area that allows the end-user to access various drawing tools that can be used to draw a particular shape, such as a circle or a hexagon, within the drafting area. Each tool may be represented by a graphical icon within the application GUI. The user application 110 is also configured to interact with the tooltip client engine 112.

The tooltip client engine 112 is a software program comprising program instructions that can be executed by the CPU 104. The tooltip client engine 112 is configured to operate in conjunction with the user application 110 to manage tooltip information that is associated with UI elements included within the user application 110. In some embodiments, a tooltip is a graphical element, such as text or a window, that is displayed when a mouse cursor is positioned over a particular user interface element.

In one embodiment, the tooltip client engine 112 is part of and included in the user application 110. In other embodiments, the tooltip client engine 112 is separate from the user application 110.

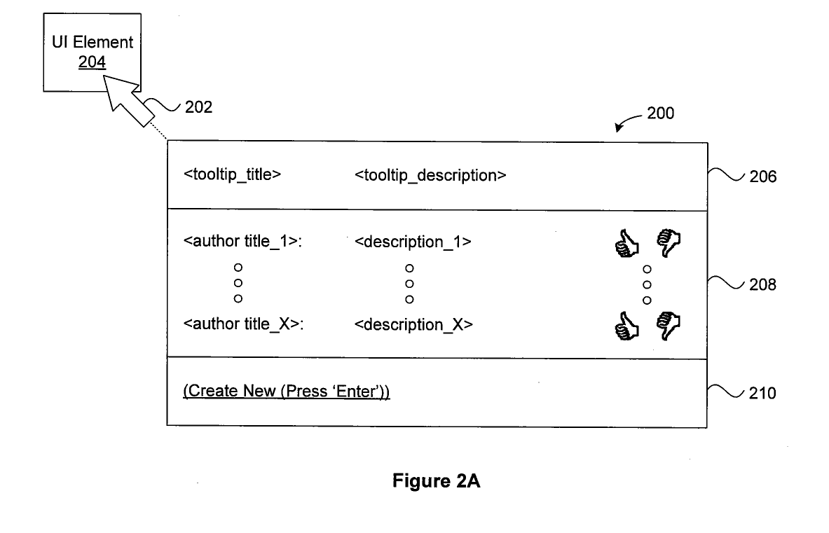

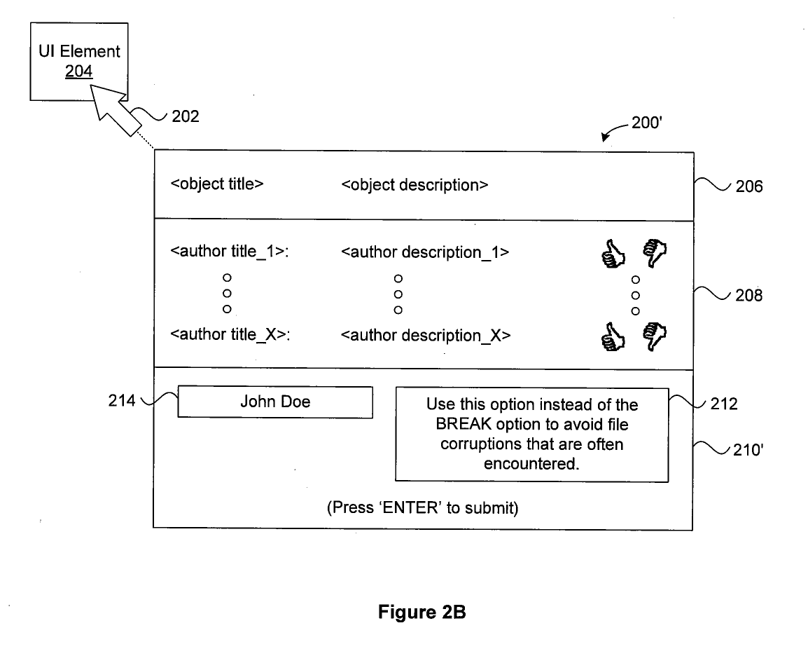

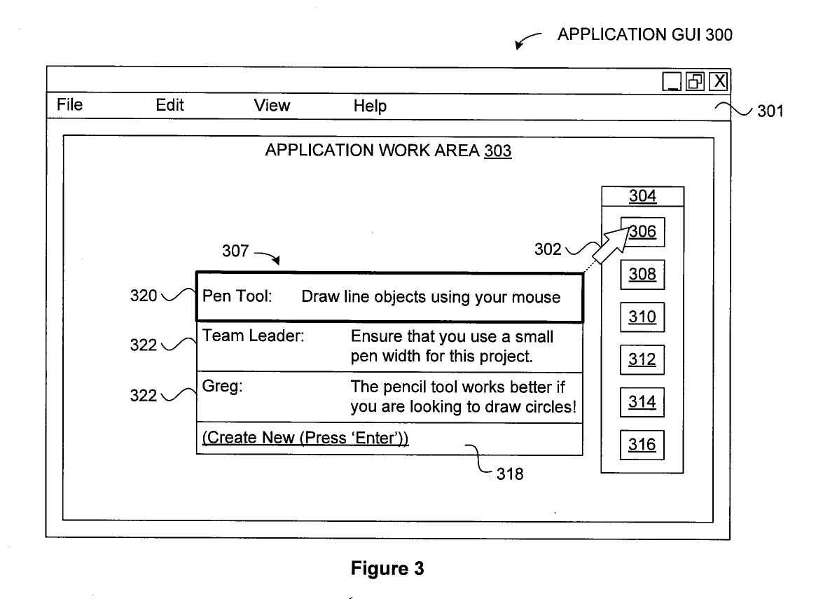

The UI elements included within the user application 110 may be toolbox buttons, toolbar buttons, or the like. The UI elements also may be objects within data files that are manipulated by the user application 110, such as building components included in a CAD data file that can be manipulated by a CAD application. When the end-user of the user application 110 positions a cursor over such a UI element (e.g. using an input device 116), the tooltip client engine 112 causes a custom tooltip associated with the UI element to be displayed to the end-user. The custom tooltip displays a default tooltip entry and any custom tooltip entries associated with the UI element, as described in greater detail in FIGS. 2A-3. In some embodiments, the custom tooltip associated with the UI element includes relevant team collaboration information that is associated with the UI element. The custom tooltip entries associated with the custom tooltip may be stored in the tooltip database 132, as described in greater detail below in conjunction with FIGS. 2A-5. The tooltip database 132 may be any type of storage device, including a distributed storage solution stored on one or more computing devices.

FIG. 2A is a conceptual diagram that illustrates a custom tooltip 200, according to one embodiment of the invention. As shown, the custom tooltip 200 includes a default tooltip entry 206, zero or more custom tooltip entries 208, and a new custom tooltip entry area 210. In one embodiment, the custom tooltip 200 is displayed when a mouse cursor 202 enters within the boundaries of the user interface (UI) element 204 and remains within the boundaries for a pre-configured threshold of time. In other embodiments, the custom tooltip 200 is displayed when an end-user accesses the UI element 204 through other means of input, such as one or more keystrokes through a keyboard, one or more mouse clicks, or one or more points of contact that are detected by a touch-sensitive surface.

As shown, the default tooltip entry 206 includes a tooltip title and a tooltip description. In some embodiments, the UI element 204 is associated with a default tooltip title and a default tooltip description that may be provided by the user application 110. For example, if the UI element 204 is a toolbox button that sets the font of a selection of text as “bold,” the tooltip title may read “Bold Font” and the tooltip description may read “Bold-faces the font of a current selection of text.” In other embodiments, the default tooltip title and/or default tooltip description may be omitted, overridden by the end-user, and/or replaced with a customized tooltip title and/or tooltip description.

The custom tooltip entries 208 display an author title, an author description, and/or voting icons depicted as thumbs-up and thumbs-down buttons. In some embodiments, additional information may be included in the custom tooltip entries 208, such as a creation date of the custom tooltip entry, a version number of the user application 110 that was used to create the custom tooltip entry, or the like. In other embodiments, hyperlinks may be included in the custom tooltip entries 208. Each hyperlink may direct the end-user to, for example, a website that includes a detailed explanation of the UI element 204, and/or a program or a data file that makes use of the UI element 204. In further embodiments, the custom tooltip entry 208 may be configured to include any technically feasible UI element including, but not limited to, pictures, videos, rich text, or the like.

As described above in FIG. 1, information associated with the custom tooltip entries 208 is stored in the tooltip database 132. In some embodiments, the tooltip database 132 includes a table that is linked to the user application 110, where the table includes columns for the information included in a custom tooltip entry. The tooltip client engine 112 communicates with the tooltip database 132 and the user application 110 to provide custom tooltip information for the UI elements that are accessible through the user application 110. In one embodiment, when the custom tooltip 200 is displayed in response to an input event, the tooltip client engine 112 transmits a UI element ID of the UI element 204 to the tooltip database 132. In response, the tooltip database 132 performs a lookup of the received UI element ID and returns all rows that are associated with the UI element ID, where each row includes information associated with the default tooltip entry 208 or the custom tooltip entries 208. The tooltip client engine 112 receives the custom tooltip entries 208 and displays each of the custom tooltip entries 208 within the custom tooltip 200. In some embodiments, the custom tooltip entries may be cached by the tooltip client engine 112 to reduce latency when the custom tooltip 200 is subsequently caused to be re-displayed. In some embodiments, a tooltip client server may be configured to mediate the communication between the tooltip client engine 112 and the tool database 132, providing increased levels of security and customization.

The new custom tooltip entry area 210 enables the end-user to add a new custom tooltip entry to the custom tooltip entries 208. In one embodiment, a hotkey such as the ‘ENTER’ key configures the custom tooltip 200 to receive a new custom tooltip entry through input from the end-user. Details of creating new custom tooltip entries are described in further detail below in FIG. 2B.

FIG. 2B is a conceptual diagram that illustrates a new custom tooltip entry within a custom tooltip 200, according to one embodiment of the invention. For example, the new custom tooltip entry area 210′ may be displayed after the ‘ENTER’ key is pressed while the custom tooltip 200 is displayed within the user application 110. As shown, the new custom tooltip entry area 210′ includes an author entry area 214 and a description area 212. In some embodiments, the author entry area 214 is automatically populated with a name of the end-user creating the new custom tooltip. The end-user may then enter a description of the new custom tooltip entry into the description area 212.

In one embodiment, when the end-user has completed his or her entry of information for the new custom tooltip entry, the ‘ENTER’ key may be used to submit the new custom tooltip entry to the tooltip database 132. In other embodiments, any technically feasible technique for confirming the new custom tooltip entry is within the scope of embodiments of the invention.

The tooltip client engine 112 receives the new custom tooltip entry from the user application 110 and transmits information associated with the new custom tooltip entry to the tooltip database 132 for storage. The tooltip database 132 creates a new row for the new custom tooltip entry and inserts the information associated with the new custom tooltip entry into the appropriate columns associated with the row. After the information associated with the new custom tooltip entry is stored in the tooltip database 132, the tooltip database 132 transmits a response to the tooltip client engine 112 and, if the response indicates a successful storage of the new custom tooltip entry, the custom tooltip 200 is updated to include the new custom tooltip entry with the other custom tooltip entries 208 associated with the UI element 204. The new entry area 210′ reverts to the new entry area 210, where the end-user may subsequently create additional new custom tooltip entries.

In other embodiments, each custom tooltip entry may be associated with one or more parameters. Examples of parameters include a set of users or a team of users that is able to view the custom tooltip entry in the custom tooltip. In some embodiments, only the end-user that created a custom tooltip entry can view the custom tooltip entry in the custom tooltip. For example, the end-user can manage his or her custom tooltip entries individually. In some embodiments, the custom tooltip entries may be stored locally on the endpoint computing device 102.

FIG. 3 is a conceptual diagram that illustrates a custom tooltip 307 displayed within a software application, according to one embodiment of the invention. As described, the user application 110 generates the application GUI 300 that is displayed on a display device. In one embodiment, the user application 110 is a CAD application, and the application GUI 300 is a CAD application GUI. Accordingly, the application GUI 300 represents just one example of an application GUI that could be generated by the user application 110, and many other user applications and application GUIs are within the scope of embodiments of the invention.

As shown, the application GUI 300 includes a menu bar 301, a UI element bar 304, a cursor 302, and an application work area 303. The cursor 302 can be manipulated by the end-user via input devices 116 and can be used to select, drag, and/or drop different graphical items within the application GUI 300. The menu bar 301 includes different menus that can be accessed by the end-user via input devices 116. The application work area 303 displays graphical data, such as drawings or three-dimensional (3D) models.

The UI element bar 304 includes UI elements 306, 308, 310, 312, 314, and 316. The UI elements within the tool bar 304 represent different tools, each of which may be selected by the end-user in order to generate or manipulate the graphical data displayed within the application work area 303. For example, the UI element 316 could represent a circle tool that, when selected by the end-user, enables the end-user to draw a circle within the application work area 303. When the end-user positions the cursor 302 over one of the UI elements within the toolbar 304, the tooltip client engine 112 accesses a custom tooltip associated with the UI element. The tooltip client engine 112 then displays the associated custom tooltip within the application GUI 300.

In one embodiment, the UI element 306 represents a pen tool that allows the end-user to draw within the application work area 303 using an input device 116. In one embodiment, a custom tooltip 307 is displayed when the cursor 302 enters within the boundaries of the UI element 306. As shown, the custom tooltip 307 displays a default tooltip entry 320 that is bordered by a bold line. Two custom tooltip entries 322 are also included in the custom tooltip 307, where the first custom tooltip entry was created by a team leader and the second custom tooltip entry was created by a team member named Greg. The custom tooltip 307 also includes the new custom tooltip entry area 318, as described above in FIGS. 2A-2B.

In some embodiments, end-user and/or project hierarchy information may be included in the tooltip database 132 to ensure that only relevant custom tooltips are displayed to end-users. For example, the tooltip client engine 112 may be configured to determine an ID of a project file being accessed by the user application 110 and only deliver custom tooltips that are relevant to that project file ID. This may be accomplished, for example, by including an additional column in the database table to store such project file ID information. In other embodiments, an end-user may create a new custom tooltip entry and provide a restricted list of end-users that are able to access the new custom tooltip entry. In further embodiments, the tooltip client engine 112 may be configured to retrieve tooltip information associated only with the current version ID of the user application 110. For example, an end-user, when creating a new custom tooltip entry, may specify a list of user application 110 version IDs or project file IDs to which the new custom tooltip entry applies and should be displayed.

In addition, in some embodiments, the end-user may subscribe to the custom tooltip entries of one or more end-users. For example, each end-user on a team of four end-users that are collaborating on a particular project may subscribe to the custom tooltip entries of their teammates. Such subscriptions allow the relevant project collaboration information to be displayed to each teammate, but not displayed to other end-users.

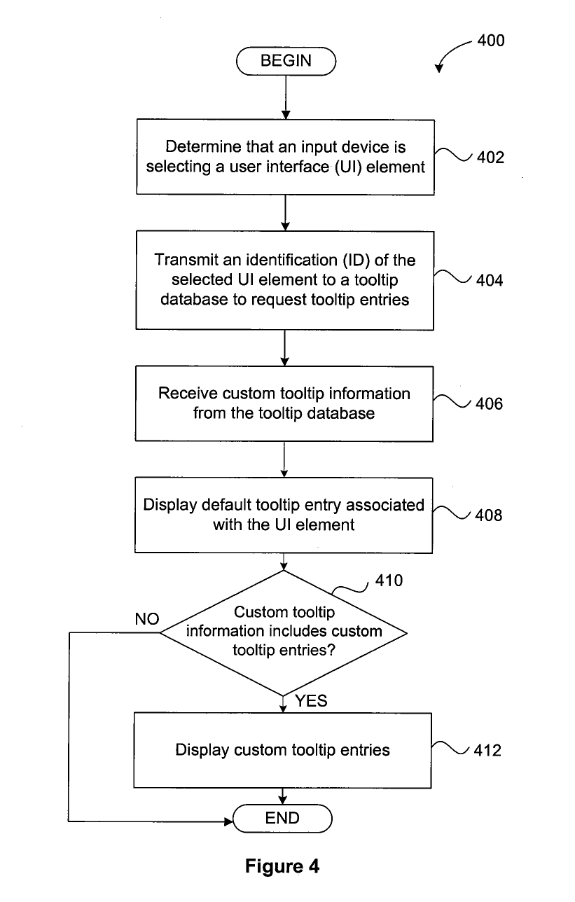

FIG. 4 is a flow diagram of method steps for displaying a custom tooltip, according to one embodiment of the invention. Although the method steps are described in conjunction with the systems of FIGS. 1-3, persons skilled in the art will understand that any system configured to perform the method steps, in any order, is within the scope of embodiments of the invention.

As shown, the method 400 begins at step 402, where a tooltip client engine determines that an input device is selecting a user interface (UI) element. In one embodiment, the UI element is included within a CAD application. In one embodiment, the selection of the UI element occurs when an end-user causes a mouse cursor to enter within the boundaries of the UI element and remain within the boundaries for a pre-configured threshold amount of time. In other embodiments, the selection occurs when the end-user accesses the UI element through other means of input, such as keystrokes through a keyboard, mouse clicks, and/or points of contact that are detected by a touch-sensitive surface.

At step 404, the tooltip client engine transmits an identification (ID) of the selected UI element to a tooltip database to request tooltip entries for a custom tooltip. In one embodiment, the selection of the UI element that is determined in step 402 also includes the ID of the UI element. For example, the UI element may be configured with an event handler that, when selected, transmits the ID of the UI element to the tooltip client engine. In other embodiments, the tooltip client engine retrieves the position of the mouse or the point of contact and references the location of the UI elements displayed to determine the selection. Upon receipt of the UI element ID, the tooltip client engine transmits the UI element ID along with any additional information, such as information associated with the end-user.

At step 406, the tooltip client engine receives custom tooltip information from the tooltip database. In one embodiment, the custom tooltip information may include a field code that specifies whether the request has successfully processed by the tooltip database, denied based on end-user permissions, or failed due to a database error. If the requested information has successfully processed, the response received by the tooltip client engine from the tooltip database includes default and/or custom tooltip entries that are associated with the UI element ID transmitted in step 404. If the request has been denied or has failed, then the field code may indicate an empty custom tooltip entry set.

At step 408, the tooltip client engine displays a default tooltip entry associated with the UI element. In one embodiment, the tooltip client engine references the CAD application that includes the UI element to retrieve a default tooltip entry for the UI element. In another embodiment, the default tooltip entry information is received from the tooltip database at step 406. The tooltip client engine renders the default tooltip entry and causes the default tooltip entry to be displayed within the CAD application GUI. Again, the default tooltip entry may be overridden to include a more detailed description than that provided by the CAD application. The tooltip is configurable to be displayed anywhere within the CAD application. In some embodiments, the UI element is not associated with a default tooltip entry, and, thus, no default tooltip entry 206 is displayed and step 408 is omitted.

At step 410, the tooltip client engine determines whether the custom tooltip information received at step 406 includes custom tooltip entries. As described above, in one embodiment, the custom tooltip information includes one of three field codes that are analyzed by the tooltip client engine. If, at step 410, the tooltip client engine determines that the response includes custom tooltip entries, then the method 400 proceeds to step 412.

At step 412, the tooltip client engine displayed the custom tooltip entries associated with the UI element. In one embodiment, each custom tooltip entry is sequentially appended to the default tooltip entry, as depicted in FIGS. 2A-3. The end-user may configure each of the custom tooltip entries to be organized and/or displayed based on preferences provided by the end-user, including but not limited to the relevance, vote count, creation date, and/or author of each custom tooltip entry. Such preferences enhance the overall end-user experience by increasing the relevance of each custom tooltip entry and eliminating any unrelated custom tooltip entries, such as custom tooltip entries created for earlier versions of the CAD application.

Referring back to step 410, if the tooltip client engine determines that the response does not include custom tooltip entries, then the method 400 terminates. The default tooltip entry that is associated with the UI element and displayed at step 408 remains displayed within the CAD application. Such a technique provides a seamless experience to the end-user since he or she is able to view the default tooltip entry of the UI element even when no custom tooltip entries have been created from the UI element.

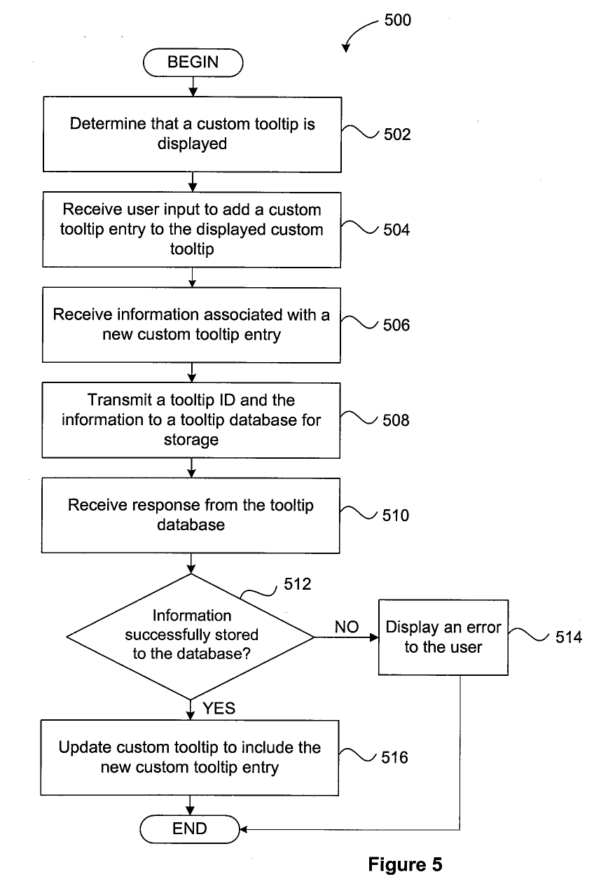

FIG. 5 is a flow diagram of method steps for adding a custom tooltip entry to a custom tooltip, according to one embodiment of the invention. Although the method steps are described in conjunction with the systems of FIGS. 1-3, persons skilled in the art will understand that any system configured to perform the method steps, in any order, is within the scope of embodiments of the invention.

As shown, the method 500 begins at step 502, where a tooltip client engine determines that a custom tooltip is displayed. In one embodiment, the custom tooltip is a tooltip that includes a default tooltip entry and does not include custom tooltip entries. In other embodiments, the custom tooltip is a tooltip that includes a default tooltip entry as well as custom tooltip entries. At step 504, the tooltip client engine receives end-user input that specifies a new custom tooltip entry. In one embodiment, a hotkey such as the ‘F2’ key is received by the tooltip client engine and the client engine updates the displayed custom tooltip to include a new custom tooltip entry UI, as described above in FIGS. 2A-3.

At step 506, the tooltip client engine receives information associated with a new custom tooltip entry. In one embodiment, an end-user inputs the information through the new custom tooltip entry UI described above in step 504. As described in FIGS. 2A-3, the new custom tooltip entry UI may include fields that receive information from the end-user that specify a description of the new custom tooltip entry and any additional information including, but not limited to, end-user permissions or compatible application version IDs or project IDs.

At step 508, the tooltip client engine transmits a tooltip ID and the information to a tooltip database for storage. In one embodiment, the tooltip ID is extracted from the UI element that is associated with the displayed tooltip described in step 502, whereupon the tooltip ID and the information are packaged and transmitted to a tooltip database for storage. In some embodiments, the end-user may be prompted to provide credentials to access the tooltip database, which provides enhanced levels of security to the custom tooltip management.

At step 510, the tooltip client engine receives a response from the tooltip database. Similar to the step 406 of the method 400, the response may include a header that specifies a field code. At step 512, the tooltip client engine determines whether the information has been successfully stored to the tooltip database. If, at step 512, the tooltip client engine determines that the information has been successfully stored to the tooltip database, then the method 500 proceeds to step 516.

At step 516, the tooltip client engine updates the custom tooltip to display the new custom tooltip entry. As described above in step 412 of the method 400, the new custom entry, which has been successfully added to the tooltip database, is displayed as a custom tooltip entry within the custom tooltip. In some embodiments, the end-user may edit or delete any custom tooltip entry that he or she has previously created.

Referring back to step 512, if the tooltip client engine determines that the information has not been successfully stored to the tooltip database, then the method 500 proceeds to step 514. At step 514, the tooltip client engine displays an error to the end-user. In some embodiments, the field code included in the header of the response is translated into a description that is readable to the end-user. For example, a field code of “ERR” may be parsed, which causes an error message to displayed, such as, “An error occurred when attempting to create the new custom tooltip entry—please try again.” Displaying errors to the end-user provides better overall feedback and ease of use to the end-user.

In sum, a tooltip client engine manages custom tooltips for UI elements of a user application. The tooltip engine communicates with a tooltip database and the user application to display relevant custom tooltips associated with UI elements included in the user application and selected by an end-user. The end-user may create new custom tooltip entries to be added to a custom tooltip. The end-user may also edit any custom tooltip entries that he or she previously created.

Advantageously, the end-user is able to easily access, generate, modify, and/or communicate to others information relevant to the UI element. Also, the user can communicate the information to others without exiting the user application interface that includes the UI element, which is far more convenient that using conventional techniques.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons skilled in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

What is claimed is:

1. A computer-implemented method for providing custom tooltips to an end-user of a software application, the method comprising:
receiving a selection of a user interface (UI) element associated with the software application; and
causing a custom tooltip to be displayed on a display device in response to the selection, wherein the custom tooltip includes one or more custom tooltip entries associated with the selected UI element created by, one or more users.

2. The method of claim 1, wherein the one or more custom tooltip entries are received from a tooltip database that stores tooltip information associated with the selected UI element.

3. The method of claim 1, wherein the custom tooltip further includes default tooltip information associated with the selected UI element.

4. The method of claim 1, further comprising the steps of:
receiving information associated with an additional custom tooltip entry; and
causing the additional custom tooltip entry to be displayed within the custom tooltip displayed on the display device.

5. The method of claim 4, further comprising the step of transmitting the information associated with the additional custom tooltip entry to a tooltip database for storage.

6. The method of claim 1, wherein a first custom tooltip entry is associated with at least one of an end-user name, a description, a vote count, a creation date, a project identification (ID) code, a list of end-users to which the first custom tooltip is displayed, and a list of valid software application versions.

7. The method of claim 1, wherein the end-user is included in a list of end-users to which the custom tooltip is capable of being displayed.

8. The method of claim 7, wherein the list of end-users comprises two or more end-users collaborating on a common project.

9. The method of claim 1, wherein a first custom tooltip entries created by a first end-user is editable by the first end-user.

10. A computer-readable medium storing instructions that, when executed by a processor, cause a computer system to provide custom tooltips to an end-user of a software application, by performing the steps of:
receiving a selection of a user interface (UI) element associated with the software application; and
causing a custom tooltip to be displayed on a display device in response to the selection, wherein the custom tooltip includes one or more custom tooltip entries associated with the selected UI element created by one or more users.

11. The computer-readable medium of claim 10, wherein the one or more custom tooltip entries are received from a tooltip database that stores tooltip information associated with the selected UI element.

12. The computer-readable medium of claim 10, wherein the custom tooltip further includes default tooltip information associated with the selected UI element.

13. The computer-readable medium of claim 10, further comprising the steps of:
receiving information associated with an additional custom tooltip entry; and
causing the additional custom tooltip entry to be displayed within the custom tooltip displayed on the display device.

14. The computer-readable medium of claim 13, further comprising the step of transmitting the information associated with the additional custom tooltip entry to a tooltip database for storage.

15. The computer-readable medium of claim 10, wherein a first custom tooltip entry is associated with at least one of an end-user name, a description, a vote count, a creation date, a project identification (ID) code, a list of end-users to which the first custom tooltip is displayed, and a list of valid software application versions.

16. The computer-readable medium of claim 10, wherein the end-user is included in a list of end-users to which the custom tooltip is capable of being displayed.

17. The computer-readable medium of claim 16, wherein the list of end-users comprises two or more end-users collaborating on a common project.

18. The computer-readable medium of claim 10, wherein a first custom tooltip entries created by a first end-user is editable by the first end-user.

19. A system for providing custom tooltips to an end-user of a software application, the system comprising:
a processor configured to:
receive a selection of a user interface (UI) element associated with the software application, and
cause a custom tooltip to be displayed on a display device in response to the selection, wherein the custom tooltip includes one or more custom tooltip entries associated with the selected UI element created by one or more users.

20. The system of claim 19, further comprising a memory storing instructions that, when executed by the processor, configure the processor to:
receive the selection of the UI element; and
cause the custom tooltip to be displayed.
